(19) United States
(12) Patent Application Publication
(10) Pub. No.: US 2002/0049864 A1
(43) Pub. Date: Apr. 25, 2002

(54) Corba jellybeans system and method

(76) Inventors: Jochen Kappel, Vence (FR); Josef Markgraf, Goldbach (DE); Michael Meadows, Sundbyberg (SE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/823,894

(22) Filed: Mar. 31, 2001

Related U.S. Application Data
(60) Provisional application No. 60/193,422, filed on Mar. 31, 2000.

(30) Foreign Application Priority Data
Mar. 31, 2000 (EP) 00106948.3-2201

(51) Int. Cl. G06F 9/44

(52) U.S. Cl. 709/315; 709/203

(57) ABSTRACT

The present invention provides a system and method for providing interaction between a client and a server. In architecture, the system includes a bean that includes at least one property that identifies the bean. Then bean that includes a property field that describes usage of an attribute for the bean, and a type that describes the bean. The present invention can also be viewed as a method for providing interaction between a client and a server. The method operates by providing at least one property that a bean represents, and providing a property field that describes usage of an attribute for the bean. A type that describes the bean is provided, and the bean is used to provide interaction between a client and a server.

### CLAIM OF PRIORITY AND CROSS REFERENCE TO RELATED APPLICATIONS

This application claims the benefit of U.S. Provisional Patent Application entitled “Targys System,” filed Mar. 31, 2000 and having Ser. No. 60/193,422, and copending U.S. Utility Patent Application entitled, “Customer Care and Billing System,” having attorney docket No. 51207-1070, filed on Mar. 28, 2001, which also claims priority to German patent application Ser. No. 00106948.3-2201, entitled “Customer Care and Billing System,” filed Mar. 31, 2000, all of the foregoing of which are now pending and are incorporated herein by reference.

### FIELD OF THE INVENTION

The present invention generally relates to computers and computer software, and more particularly, to a system and method for CORBA jellybeans.

### DESCRIPTION OF RELATED ART

In order to be able to respond to frequent changes in the telecommunications industry, any system needs to be highly flexible and scanable. The systems also have to be able to be quickly and easily configured and adapt the software to meet various demands without extensive programming efforts to implement such changes.

To ensure interoperability with other systems and allowing programming language independent implementations, a common object request broker architecture (“CORBA”) is one system chosen to be used as a basis for communication between components within an application server. CORBA specifies that a system provides interoperability between objects in a heterogeneous, distributed environment in a manner that is transparent to the programmer. CORBA is one such broker architecture that enables applications to communicate with one another no matter where they are located. However, there are instances when CORBA does not provide complete heterogeneous communication.

Thus, a heretofore-unaddressed need exists in the industry to address the aforementioned deficiencies and inadequacies.

### SUMMARY OF THE INVENTION

The present invention provides a system and method for providing interaction between a client and a server. Briefly described, in architecture, the system of the preferred embodiment can be implemented as follows. The system includes a bean that includes at least one property that identifies the bean. The bean includes a property field that describes usage of an attribute for the bean, and a type that describes the bean.

The present invention can also be viewed as a method for providing interaction between a client and a server. In this regard, the preferred method can be broadly summarized by the following steps. The method operates by providing at least one property that a bean represents, and providing a property field that describes usage of an attribute for the bean. A type that describes the bean is provided, and the bean is used to provide interaction between a client and a server.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views. In the drawings:

FIG. 1 is a block diagram illustrating an example of a network in which the CORBA jellybeans may be implemented. FIG. 2 is a block diagram illustrating an example of the architecture of the CORBA jellybeans and their interaction with other components.

FIG. 3 is a block diagram illustrating an example of a computer system utilizing an operating system and CORBA jellybeans of the present invention.

FIG. 4 is a flow chart illustrating an example of the process flow of the CORBA jellybeans of the present invention, as shown in FIG. 2 and FIG. 3.

FIG. 5 is a flow chart illustrating an example of the process flow of the automatic generation of CORBA jellybeans of the present invention, as shown in FIGS. 2, 3 and 4.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

The essential means by which a client framework can interact with a server is by the use of “CORBAJellyBeans.” CORBAJellyBeans are client classes that wrap server classes with a Java bean interface. There will be a CORBAJellyBean for each server object class, as well as for the essential classes in the client framework.

The essential elements of the CORBA jellybeans are their properties. For these, the primary properties are the properties for the information present in the domain object that the bean represents (i.e., the main object attribute values). In addition, for 10 each of these values, there can be property fields that describe usage of an attribute in a GUI (i.e., read only flags, visible attributes [hide/show] and field mass). The later can be obtained from information in a meta application dictionary at run time or at the CORBA jellybean generation time. Since attribute data should be cached on a client, a CORBA jellybean will have its own copy of the information in a server object and this information should be doubled to allow for undue behavior. Moreover, there should be an internal value showing whether or not the value of the property within the jellybean has changed.

CORBA jellybeans replace the adaptor layer in previous client server architectures. The CORBA jellybeans are invisible beans, that is, they are not part of the presentation layer to the client. These CORBA jellybeans are a library of invisible beans that provide reusable classes to the application program or to help solve problems in the area of internationalization, undue formatting, and the like. Internationalization is a localization based upon the user of an application. This localization includes day/time formatting, currency formatting, number formatting, language and font used in labels, help messages and error messages regarding whether the error message originates in the client or server. A second object has to do with the correct language and formatting based upon the preferences of the customer associated with the data. The format of the data is presented on parameters stored in the server. For example, certain currency values for a customer need to be displayed in the format preferred by the customer and not in the format indicated by the local application.

CORBA jellybeans for single objects are included for each type, and include, but are not limited to, interface, structure, etc. CORBA Jellybeans for containers are similar to CORBA jellybeans for single objects. CORBA Jellybeans for containers are not generated automatically because they shall be implemented by an adaptor so they can be used in models.

There are three kinds of objects that are represented by CORBA jellybeans in transaction handling. There are transient server objects that are associated with the transaction context, persistent server objects that have persistent state and an identity, and value objects that provide all kinds of helper objects such as details and structures.

CORBA jellybeans may have certain predefined events. For example, a changed event could be generated when a property value within the CORBA jellybean is changed. Since a CORBA jellybean can communicate with a domain object, each instance must be associated and use the proper object domain object client stub. Thus, an essential element of a CORBA jellybean is its link with a client stub, such as a GUI interface. Also essential is the mapping of its property values to the proper proxy method in the stub.

There are certain other behaviors that a CORBA jellybean has, since all the interaction with the main objects is done using a transaction context. Each bean must have a handle to a transaction contact, which can be propagated to the bean at creation time. The bean must be able to save its information, i.e., send and apply changes made in a GUI to the server object using the transaction context. There should be an undo facility to allow a GUI to restore the state of an object to the last saved state. Finally, there should be a refresh mechanism that allows a bean to refresh its viewer pay domain object, i.e., in case of loss or failure.

The data for the bean properties will be obtained via the associated stub from the server. To provide optimal throughput, it should be possible to configure how the data is passed back and forth. For example, all the data could be passed in both directions every time, only the necessary value properties could be loaded or sent back. In this way, the bean could only retrieve those properties that were linked in a GUI and only send back changed information. This will require behavior that allows the bean to “know” if a property is linked and whether or not the property is changed.

In addition to “beanified” domain objects, there should be some more advanced model types, for example, model beans that can be well-used for an attribute list, tree structure, and finally lists in general. The general usage and automatic creation of CORBA jellybeans is herein defined in further detail.

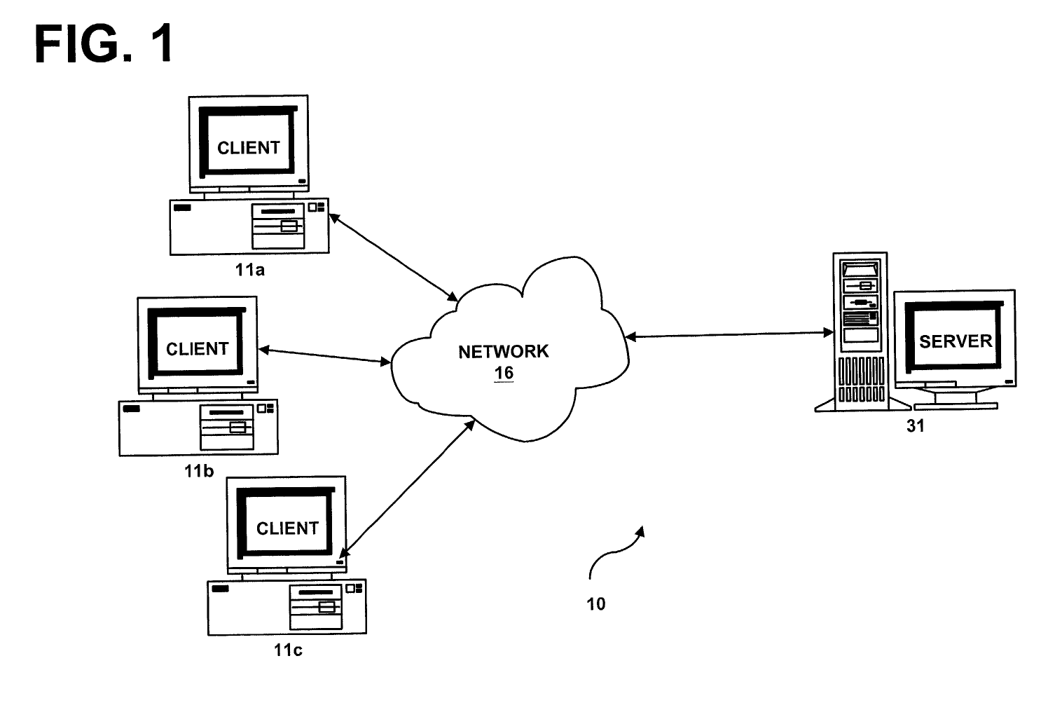

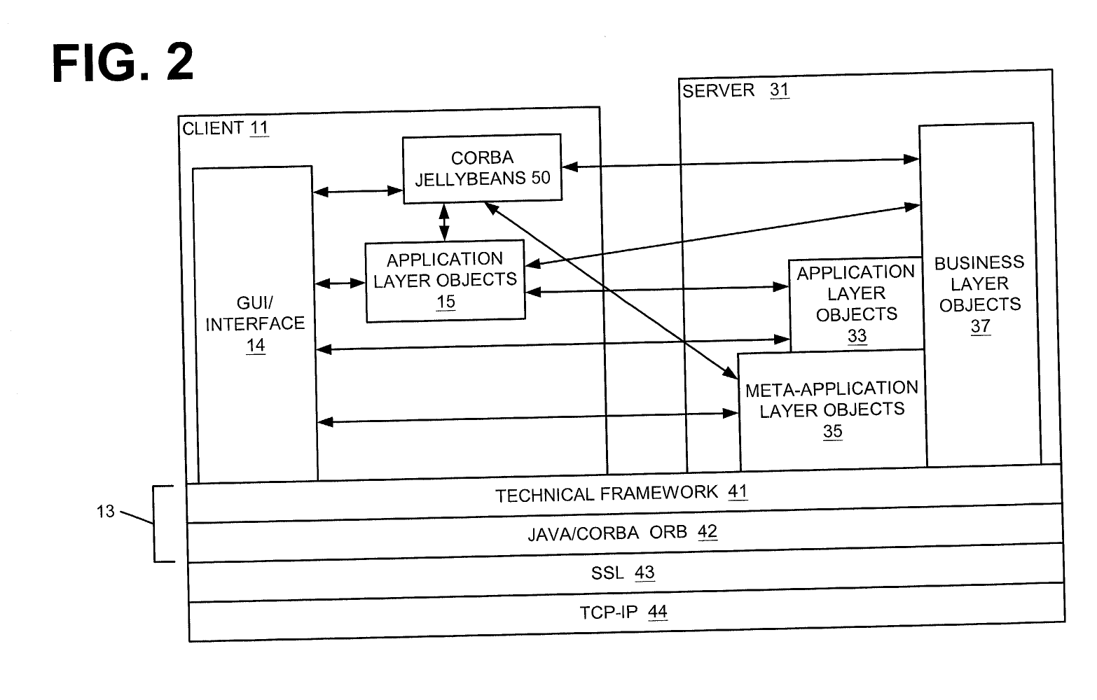

Referring now to the drawings, wherein like reference numerals designate corresponding parts throughout the drawings, FIG. 1 is a block diagram that portrays a diagram of a network that illustrates the flexibility, expandability, and platform independence in which the present COBRA jellybean 50 may be implemented. Referring to FIG. 1, a series of client computers 11a, 11b, 11c are connected to a server computer 31 via a network 16. The network 16 may be, for example, but is not limited to, a dial-in network, local area network (LAN), wide area network (WAN), public switched telephone network (PSTN), Intranet, Internet, Ethernet type networks, and the like. The client computers 11a, 11b, 11c (hereinafter, 11) may be located within a LAN, WAN, PSTN, Intranet, Internet, Ethernet type networks, or the like. It should be noted that the number of client computers and server computers may differ from the number presently illustrated. Further, it should also be noted that, that the preferred embodiment of the invention describes the functionality provided by a server computer 31.

Illustrated in FIG. 2 is a block diagram of an example of the architecture of the CORBA jellybeans 50 and their interaction with other client/server components. CORBA jellybeans 50 can provide simplified transaction handling between the GUI interface 14 application and application layer objects 15 with the components in the server 31. Furthermore, the CORBA jellybeans 50 can serve as cache entities. Non-transient property values are cached on the client side while being fetched for the very first time. Therefore, when requesting property values one more time, the values are not requested from the server via the network, comprising of the technical framework 41 Java/CORBA Orb 42, the secure socket layer 43, and the TCP-IP layer 44, but are instead fetched from the local cache. The cache-in properties of the CORBA jellybeans, which are fetched via the network are summarized into property sets. The sets are fetched as one network package, thus increasing performance because the compounding data to bigger network packages lowers the overall transfer value.

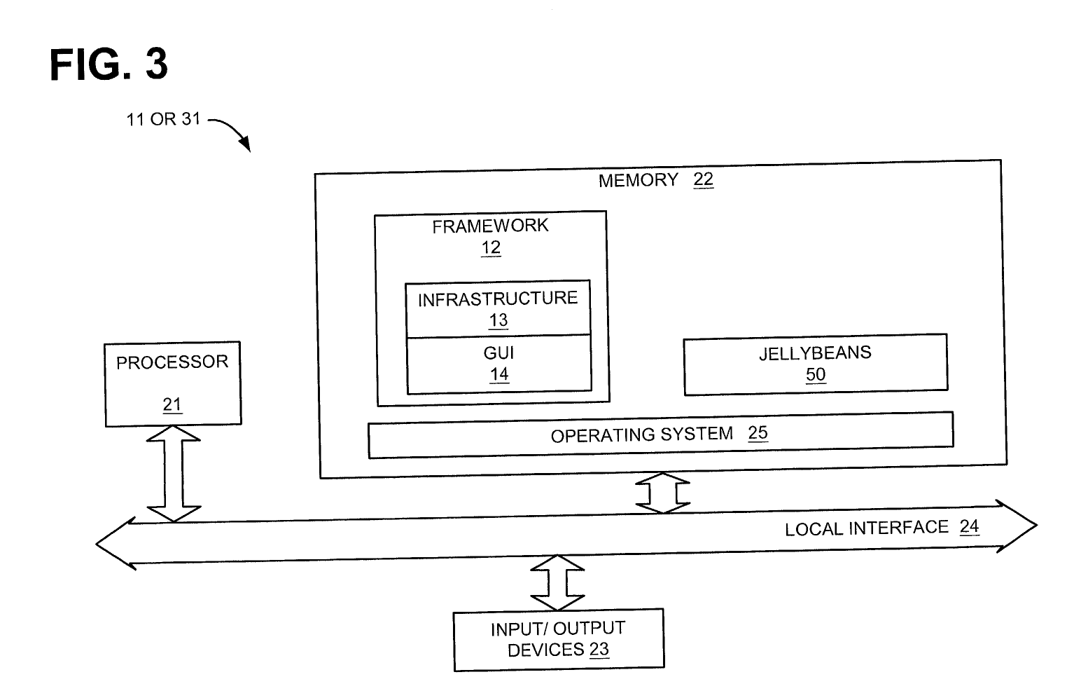

An example of a general-purpose computer that can implement the CORBA jellybeans 50 of the present invention is shown in FIG. 3. The CORBA jellybeans 50 of the invention can be implemented in software (e.g., firmware), hardware, or a combination thereof. In one embodiment, the CORBA jellybeans 50 is implemented in software, as an executable program, and is executed by a special or general purpose digital computer, such as a personal computer (PC; IBM-compatible, Apple-compatible, or otherwise), workstation, minicomputer, personal digital assistant (PDA) or mainframe computer.

Generally, in terms of hardware architecture, as shown in FIG. 3, the computers 11 or 31 include a processor 21, memory 22, and one or more input and/or output (I/O) devices 23 (or peripherals) that are communicatively coupled via a local interface 24.

The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 21 is a hardware device for executing software that can be stored in memory 22. The processor 21 can be virtually any custom made or commercially available processor, a central processing unit (CPU) or an auxiliary processor among several processors associated with the computer 11 and/or 31, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 22 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 22 may incorporate electronic, magnetic, optical, and/or other types of storage media. Note that the memory 22 can have a distributed architecture, where various components are situated remote from one another, but can be accessed by the processor 21.

The software in memory 22 may include one or more separate programs, each of which comprises an ordered listing of executable instructions for implementing logical functions. In the example of FIG. 2, the software in the memory 22 includes the CORBA jellybeans 50 and a suitable operating system (O/S) 25.

A non-exhaustive list of examples of suitable commercially available operating systems 25 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 25 essentially controls the execution of other computer programs, such as the CORBA jellybeans 50, and provides scheduling, input-output control, file and data management, memory management, and communication control and related services.

The CORBA jellybeans 50 may be a source program, executable program (object code), script, or any other entity comprising a set of instructions to be performed. When a source program, then the program is usually translated via a compiler, assembler, interpreter, or the like, which may or may not be included within the memory 22, so as to operate properly in connection with the O/S 25. Furthermore, the CORBA jellybeans 50 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 23 may include input devices, for example but not limited to, a keyboard, mouse, scanner, microphone, etc. Furthermore, the I/O devices 23 may also include output devices, for example but not limited to, a printer, display, etc. Finally, the I/O devices 23 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11 and/or 31, is a PC, workstation, or the like, the software in the memory 22 may further include a basic input output system (BIOS) (omitted for simplicity). The BIOS is a set of essential software routines that initialize and test hardware at startup, start the O/S 25, and support the transfer of data among the hardware devices. The BIOS is stored in ROM so that the BIOS can be executed when the computer 11 and/or 31 is activated.

When the computer 11 and/or 31 is in operation, the processor 21 is configured to execute software stored within the memory 22, to communicate data to and from the memory 22, and to generally control operations of the computer 11 and/or 31 pursuant to the software. The CORBA jellybeans 50 and the O/S 25 are read, in whole or in part, by the processor 21, perhaps buffered within the processor 21, and then executed.

When the CORBA jellybeans 50 is implemented in software, as is shown in FIG. 3, it should be noted that the CORBA jellybeans 50 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The CORBA jellybeans 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

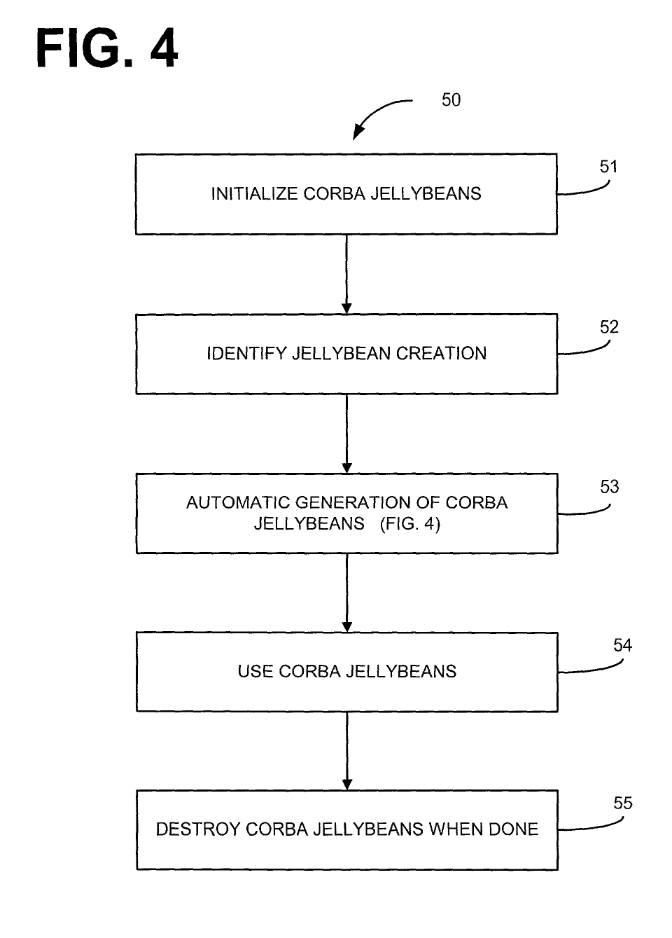

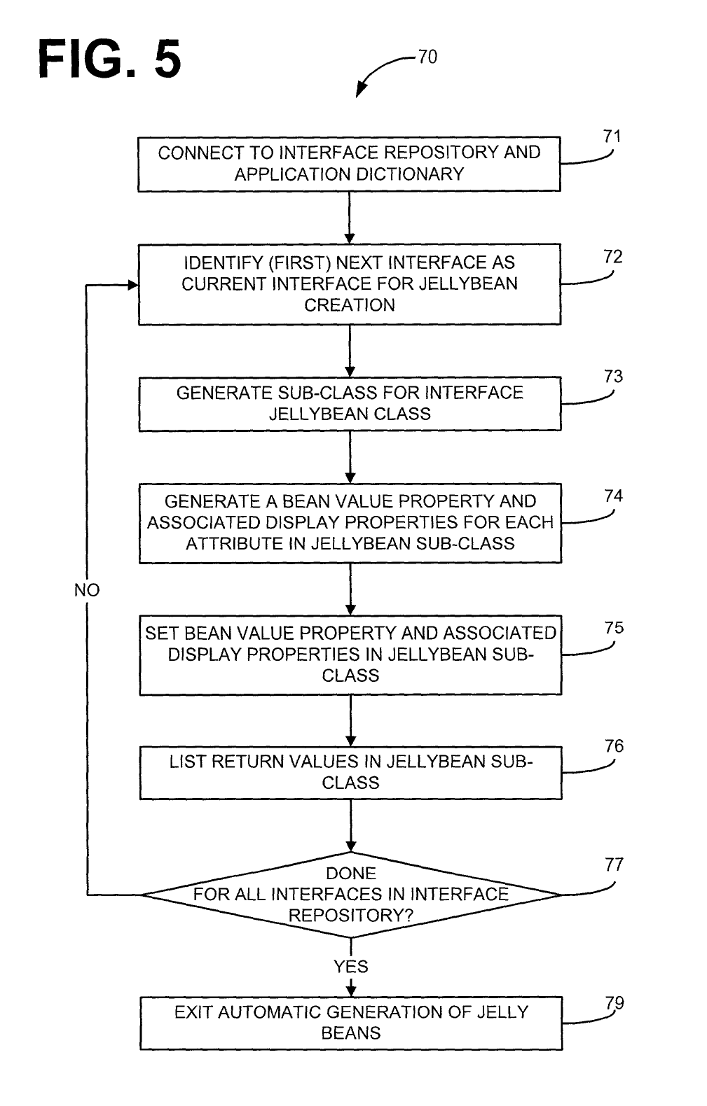

FIG. 4 is a data flow chart illustrating an example of the process flow of the CORBA jellybeans of the present invention, as shown in FIGS. 2 and 3. First, the CORBA jellybeans are initialized at step 51. At step 52, the jellybeans identify when the CORBA jellybeans are to be created. The automatic generation of jellybeans occurs at step 53 and is herein defined in further detail with regard to FIG. 5. At step 54, the CORBA jellybeans are utilized in their general operation and upon expiration of their operation, they are destroyed when done at step 55.

Illustrated in FIG. 5 is a flow chart of an example of the process flow of the automatic generation of jellybeans. First, the automatic generation of jellybeans 70 connects to an interface repository and application dictionary at step 71. At step 72, there is an identification of the first or next interface as the current interface for jellybean creation. At step 73, the automatic generation of jellybean 70 generates the subclass for the interface jellybean class. At step 74, the generation of the jellybean value property and associated display properties for each attribute in the CORBA jellybean subclass is performed. At step 75, the CORBA jellybean value property and associated display properties in the CORBA jellybean subclass are set. At step 76, the automatic generation of CORBA jellybeans 70 returns values in the CORBA jellybean subclass.

At step 77, the automatic generation of jellybean 70 determines whether it is done creating jellybeans for all interfaces and the interface repository. If it is determined at step 77 that not all interfaces in the interface repository have had CORBA jellybeans created, the automatic generation of CORBA jellybeans 70 then returns to repeat step 72 through 77. However, if it is determined at step 77 that all interfaces in the interface repository have had CORBA jellybeans created, the automatic generation of CORBA jellybeans 70 exits at step 79.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing interaction between a client and a server, comprising:
means for providing at least one property that a bean represents;
means for providing a property field that describes usage of an attribute for the bean;
means for providing a type that describes the bean; and
means for using the bean to provide interaction between a client and a server.

2. The system of claim 1, further comprising:
means for mapping the at least one property to a method in a stub.

3. The system of claim 1, further comprising:
means for providing a handle for the bean.

4. The system of claim 3, further comprising:
means for using the handle for transaction contact.

5. The system of claim 1, further comprising:
means for indicating if a value of one of the at least one property has changed.

6. A method for providing interaction between a client and a server, the method comprising steps of:
providing at least one property that a bean represents;
providing a property field that describes usage of an attribute for the bean;
providing a type that describes the bean; and
using the bean to provide interaction between a client and a server.

7. The method of claim 6, further comprising the step of:
mapping the at least one property to a method in a stub.

8. The method of claim 6, further comprising the step of:
providing a handle for the bean.

9. The method of claim 8, further comprising the step of:
using the handle for transaction contact.

10. The method of claim 9, further comprising the step of:
indicating if a value of one of the at least on e property has changed.

11. A computer readable medium for providing interaction between a client and a server, comprising:
logic that provides at least one property that a bean represents;
logic that provides a property field that describes usage of an attribute for the bean;
logic that provides a type that describes the bean; and
logic that uses the bean to provide interaction between a client and a server.

12. The computer readable medium of claim 11, further comprising:
logic that maps the at least one property to a method in a stub.

13. The computer readable medium of claim 11, further comprising:
logic that provides a handle for the bean.

14. The computer readable medium of claim 13, wherein the logic that validating further comprises:
logic that uses the handle for transaction contact.

15. The computer readable medium of claim 11, further comprising:
logic that indicates if a value of one of the at least one property has changed.

16. A system for providing interaction between a client and a server, comprising:
a bean, wherein said bean further comprises:
at least one property that identifies the bean;
a property field that describes usage of an attribute for the bean; and
a type that describes the bean.

17. The system of claim 16, wherein the bean maps the at least one property to a method in a stub.

18. The system of claim 16, wherein the bean further comprises:
a handle for the bean.

19. The system of claim 18, wherein the handle is used for transaction contact.

20. The system of claim 16, wherein the at least one property includes a value to indicate that at least one property has changed.
